(19) United States
(12) Patent Application Publication
(10) Pub. No.: US 2024/0382830 A1
(43) Pub. Date: Nov. 21, 2024

(54) SYSTEM AND METHOD OF SPACE MOVEMENT IN GAME, AND RECORDING MEDIUM STORING PROGRAM EXECUTING THE METHOD

(71) Applicant: FUNNY STORM, Seongnam-si (KR)

(72) Inventors: Chunggil YU, Suwon-si (KR); Jeong-Hwan IM, Hanam-si (KR)

(73) Assignee: FUNNY STORM, Seongnam-si (KR)

(21) Appl. No.: 18/665,165

(22) Filed: May 15, 2024

(30) Foreign Application Priority Data
May 18, 2023 (KR) 10-2023-0064604
Mar. 11, 2024 (KR) 10-2024-0034085

(51) Int. Cl. A63F 13/216

(52) U.S. Cl. CPC A63F 13/216

(57) ABSTRACT

Disclosed are a system and a method of space movement in a game, and a recording medium storing a program executing the method, and the method includes: providing an accessed client terminal with a client program for executing a game; and when receiving a portal designation request for a target place in an activity area of a game space during game execution from the client terminal, storing information including a location value for the target place determined from a GPS value of the client terminal as portal information, and when a user selects a specific portal for movement during game execution, causing a game space to be moved to a target place by using the portal information and providing a game environment configuration linked to real-world environmental information of the real world corresponding to the location value of the target place.

### CROSS-REFERENCE TO RELATED APPLICATION

This application claims priority to and the benefit of Korean Patent Application No. 10-2023-0064604 filed in the Korean Intellectual Property Office on May 18, 2023, and Korean Patent Application No. 10-2024-0034085 filed in the Korean Intellectual Property Office on Mar. 11, 2024, the entire contents of which are incorporated herein by reference.

### BACKGROUND OF THE INVENTION

### (a) Field of the Invention

The present disclosure relates to a system and a method of space movement in a game, and a recording medium for storing a program executing a method, and more particularly, to a technology in which a player character of a user in a game space is capable of storing information about a specific place in a game and moving to a stored specific place from another game place through the information.

### (b) Description of the Related Art

With the development of mobile technology, the time and space constraints of building games are decreasing and game players are becoming more interactive. As game consumers have diversified, there have been various attempts to merge the gaming space with the real world.

Existing games like Pokémon Go have applied familiar Pokémon characters to an augmented reality games, reigniting a boom in consumption of the original Pokémon characters. However, when the game space is connected with the real world, there were limitations in the game activity area.

Specifically, there have been cases where game content has been provided based on the user's actual movements and motion in the real world and the areas in which the user may physically move.

In this case, when game content is provided based on the user's physical space, the range of environments in which the game may be actually played is narrowed, thereby limiting the diversity of game content.

### SUMMARY OF THE INVENTION

The present disclosure attempts to provide a technology that configures a game environment by utilizing current real-time environmental information based on a current location of a user and simultaneously stores information about a specific place, allows the user to move a game space by utilizing the stored information about the specific place, and provides a game environment configuration matching real-world environmental information of a target place after movement.

An exemplary embodiment of the present disclosure provides a system for space movement in a game, the system including: a service server for receiving membership information of game service users from client terminals and registering the received membership information, and executing membership management; and a game server for providing a client program for executing a game to the client terminal, in which when the game server receives a portal designation request for a target place in an activity area of a game space during game execution from the client terminal, the game server stores information including a location value for the target place determined from a GPS value of the client terminal as portal information, and when a user selects a specific portal for movement during game execution, the game server causes a game space to be moved to a target place by using the portal information and provides a game environment configuration linked to real-world environmental information of the real world corresponding to the location value of the target place.

In this case, the portal information may further include a unique index value for the target place.

Further, the game server may include: a client program providing unit for providing the client terminal with the client program for executing the game; a game providing unit for providing player information; and a portal processing unit for receiving the portal designation request and storing the portal information for the target place, and providing the client terminal with the portal information when the client terminal makes a request for the portal information to cause the client terminal to display a map image based on the location value of the target place by using the portal information when the user selects a specific portal during game execution, and provide a game environment configuration matching real-world environmental information of the real world corresponding to the location value of the target place when a player enters the map image such that game space of the player is moved.

Further, the portal processing unit may include: a portal information storing unit for receiving the portal designation request and storing the portal information for the target place; a portal information sharing unit for providing information about a specific portal to a designated other user upon receiving a sharing request for the specific portal from the client terminal; and a movement unit for providing the client terminal with the information of the specific portal when the user selects the specific portal for movement during game execution, and causing the client terminal to display a map image of the target place and provide a game environment configuration matching real-world environmental information.

Further, the portal information sharing unit may cause a portal transmission symbol to be displayed on the game screen of designated other user when receiving a portal sharing request, and when the other user approves addition of a corresponding portal, the portal information storing unit may store information about the corresponding portal as portal information of the other user.

Further, the client program providing unit may also provide a matching table defining a game environment configuration linked based on real-world environmental information through the client program to cause the client terminal to provide a game environment configuration matching real-world environmental information of the real world corresponding to a location value of a target place based on the matching table by using the portal information when the user selects a specific portal during game execution.

Further, the real-world environmental information may include one or more of temperature, country, weather, altitude, time, wind, fog, UV light, precipitation, fine dust, stock price information, and traffic information.

Another exemplary embodiment of the present disclosure provides a method of space movement in a game by a system, the method including: a) providing an accessed client terminal with a client program for executing a game; and b) when receiving a portal designation request for a target place in an activity area of a game space during game execution from the client terminal, storing information including a location value for the target place determined from a GPS value of the client terminal as portal information, and when a user selects a specific portal for movement during game execution, causing a game space to be moved to a target place by using the portal information and providing a game environment configuration linked to real-world environmental information of the real world corresponding to the location value of the target place.

Further, the portal information may further include a unique index value for the target place.

Further, the operation b) may include receiving the portal designation request and storing the portal information for the target place, and providing the client terminal with the portal information when the client terminal makes a request for the portal information to cause the client terminal to display a map image based on the location value of the target place by using the portal information when the user selects a specific portal during game execution, and provide a game environment configuration matching real-world environmental information of the real world corresponding to the location value of the target place when a player enters the map image such that game space of the player is moved.

Further, the method may further include providing information about a specific portal to a designated other user upon receiving a sharing request for the specific portal from the client terminal.

Further, the method may further include, when receiving approval to add a corresponding portal from other user, storing information about the corresponding portal as portal information of the other user.

In this case, the operation a) may include providing a matching table defining a game environment configuration linked based on real-world environmental information in which a user is located through the client terminal, and the operation b) may include causing the client terminal to provide a game environment configuration based on the matching table by using the portal information when the user selects a specific portal during game execution.

Further, the real-world environmental information includes one or more of temperature, country, weather, altitude, time, wind, fog, UV light, precipitation, fine dust, stock price information, and traffic information.

Still another exemplary embodiment of the present disclosure provides a recording medium for storing a program executing a method of performing space movement in a game, in which the method includes: storing, by a device, a matching table including a game environment configuration matching each of real-world environmental information; providing, by the device, as portal information, information including a location value for a target place determined from a GPS value of the device in an activity area of a game space during game execution; receiving, by the device, a list of stored portals and, when a specific portal is selected for movement through the game space, receiving, based on information about the portal, a map image of the target place and real-world environmental information of the real word corresponding to the location value of the target place; displaying, by the device, a map image of the target place; and when the player enters the map image, providing, by the device, based on the matching table, a game environment configuration matching real-world environmental information of the target place.

Further, the portal information may further include a unique index value for the target place.

Further, the real-world environmental information may include one or more of temperature, country, weather, altitude, time, wind, fog, UV light, precipitation, fine dust, stock price information, and traffic information.

As described above, according to the present disclosure, a game environment may be configured by utilizing real-time environmental information based on a current location of a user and simultaneously a game space may be moved to a target place by utilizing stored information about a specific place, and provide a game environment configuration that matches real-world environmental information of the target place after movement.

Therefore, the users may receive an interaction available game environment that matches real-world environmental information not only in the game area based on their current location, but also in places to which the users moved, and enjoy games with expanded diversity.

### BRIEF DESCRIPTION OF THE DRAWINGS

FIG. 1 is an overall configuration diagram illustrating a system according to an aspect of the present disclosure.

FIG. 2 is a configuration diagram illustrating a service server according to an aspect of the present disclosure.

FIG. 3 is a configuration diagram illustrating a game server according to an aspect of the present disclosure.

FIG. 4 is a detailed configuration diagram illustrating a portal processing unit of FIG. 3.

FIGS. 5 (a) and 5 (b) are example screens illustrating a portal according to an aspect of the present disclosure.

FIG. 6 is a detailed configuration diagram illustrating a client terminal according to an aspect of the present disclosure.

FIG. 7 is a detailed configuration diagram illustrating a game environment configuration unit of a client terminal according to an aspect of the present disclosure.

FIGS. 8 (a) and 8 (b) are example screens for game space movement according to an aspect of the present disclosure.

FIG. 9 is a table for configuring an interaction available game environment that is provided while matching real-world environmental information according to an aspect of the present disclosure.

FIG. 10 is a general flowchart illustrating a method of storing portal information for a game space by a system according to an aspect of the present disclosure.

FIG. 11 is a general flowchart illustrating a method of moving and playing a game space based on portal information on a client terminal according to an aspect of the present disclosure.

### DETAILED DESCRIPTION OF THE EMBODIMENTS

Hereinafter, exemplary embodiments of the present disclosure will be described with reference to accompanying drawings so as to be easily understood by a person ordinary skilled in the art. However, the present disclosure may be variously implemented and is not limited to the following embodiments. Accordingly, the drawings and description are to be regarded as illustrative in nature and not restrictive. Like reference numerals designate like elements throughout the specification.

Throughout the specification, unless explicitly described to the contrary, the word “comprise”, and variations such as “comprises” or “comprising”, will be understood to imply the inclusion of stated elements but not the exclusion of any other elements.

In addition, the terms “ . . . er”, “ . . . or”, “a . . . module” described in the specification mean units for processing at least one function and operation and may be implemented by hardware components or software components and combinations thereof.

The devices described in the present disclosure are formed of hardware including at least one processor, a memory device, a communication device, and the like, and a program executable in combination with the hardware is stored at a designated location. The hardware has the configuration and performance to execute the method of the present disclosure. The program includes instructions implementing the method of the operation of the present disclosure described with reference to the drawings, and is combined with hardware, such as a processor and memory device, to execute the present disclosure. In the present specification, “transmit or provide” may include not only direct transmission or provision, but also indirect transmission or provision through another device or by utilizing a bypass path.

In the present specification, expressions in the singular may be construed as either singular or plural, unless the explicit words “one” or “single” or the like are used.

In the present specification, regardless of the drawing, the same reference numeral refers to the same component, and “and/or” includes each and every combination of one or more of the recited components.

Terms including an ordinary number, such as first and second, are used for describing various constituent elements, but the constituent elements are not limited by the terms. The terms are used only to discriminate one constituent element from another constituent element. For example, without departing from the scope of the present disclosure, the first component may be named as the second component, and similarly, the second component may be named as the first component.

In the flowchart described with reference to the drawing, the order of operations may be changed, several operations may be merged, some operations may be divided, and specific operations may not be performed.

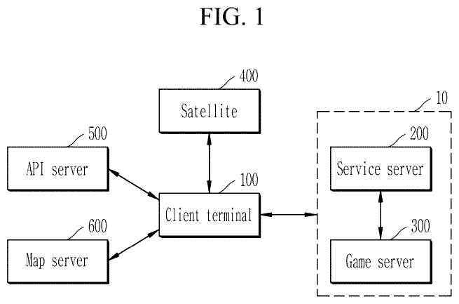

First, as illustrated in FIG. 1, a user may play a game via a client terminal 100. The client terminal 100, for example, a mobile terminal, may access a game server 300, download a necessary client program, and play a target game. At this time, the client terminal 100 may also register for membership by registering information and receive membership services via the service server 200.

The client terminal 100 may receive GPS information via the satellite 400.

The client terminal 100 may then receive real-world environment data and map data based on a current location in the game space via an API server 500 and a map server 600. Through this, the client terminal 100 may apply information, such as current weather, temperature, humidity, and time, to the game environment configuration in real time.

In other words, according to the present disclosure, the client terminal 100 may call the map server 600 and the API server 500 by using GPS information.

Then, the client terminal 100 may configure a matching game environment according to the current real-world environmental information. The game space may be configured according to the current real-world environmental information data changes and interacted with the user during the game play process. Thus, the user may be provided with a realistic and diverse game environment.

Each of a variety of real-world environment factors that may be obtained through APIs, such as temperature, country, weather, altitude, time, wind, fog, UV light, precipitation, fine dust, stock price information, or traffic information are configured as the matching game environment, so that players may enjoy a game in a game environment that is linked to the real world.

The client terminal 100 may request to store information including a location value for a specific place in a game space as portal information, and may provide map data and game environment configuration matching the portal information when a user wishes to move through the game space via the portal. This will be described later in detail.

The service server 200 may manage user access, and may register membership information of game service users and perform membership management. The game server 300 may provide a client program for playing a game upon request of the client terminal 100, and may provide player data for starting the game.

In some embodiments, the game server 300 may receive real-world environmental information of the current location and provide the client terminal 100 with the received environmental information, and may provide the client terminal 100 with game environment configuration data.

The API server 500 may provide environmental information of the current location based on GPS values of the client terminal 100 determined from the satellite 400.

For example, the API server 500 may provide various environmental information, such as weather, temperature, wind speed, precipitation, fine dust, stock price information, traffic information, and the like.

The map server 600 may provide the requested map data based on the GPS values of the client terminal 100. The map server 600 may provide the map data in a tiled format representing geographic features of the region.

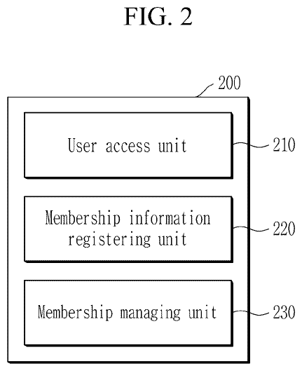

In the meantime, FIG. 2 is a detailed configuration diagram of the service server 200 in accordance with an aspect of the present disclosure.

As illustrated, the service server 200 may include a user access unit 210, a membership information registering unit 220, and a membership management unit 230.

The user access unit 210 is an interface with the client terminal 100 and may receive requests and information from the client terminal 100.

The membership information registering unit 220 may collect and register information about users who register as members.

The membership management unit 230 may execute history management for registered members or event setting/management provided to members.

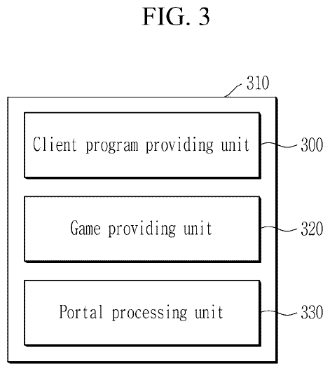

Hereinafter, the game server 300 according to an aspect of the present disclosure will be described in more detail with reference to FIG. 3.

The game server 300 may include a client program providing unit 310, a game providing unit 320, and a portal processing unit 330.

The client program providing unit 310 may provide the client terminal 100 with programs required for game play.

The client program providing unit 310 may also provide an interaction available game environment configuration matching table that defines an interaction available game environment configuration that is linked based on the real-world environmental information in which the user is located, allowing the client terminal 100 to configure an interaction available game environment matching according to the received real-world environmental information.

The game providing unit 320 may provide player information to cause a user to execute a game, and in some embodiments, the game providing unit 320 may directly provide game data for configuring the interaction available game environment based on the matching table described above.

The portal processing unit 330 may store information about a target place designated by a user during game play as portal information, and share the information with other designated users, so that the users may move the game space to the target place through the portal upon request.

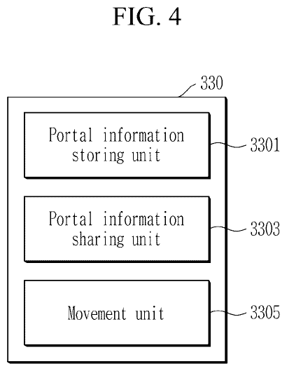

Hereinafter, the portal processing unit 330 will be described in detail with reference to FIG. 4.

The portal processing unit 330 may include a portal information storing unit 3301, a portal information sharing unit 3303, and a movement unit 3305.

The portal information storing unit 3301 may store information including a location value and a unique index for a target place as portal information.

Specifically, the client terminal 100 may first update GPS information thereof from the satellite 400 at a set time interval.

In an activity area of the game space, a player may enter and explore a target place, such as a capture zone, and in this case, the player may attempt to store the target place information as portal information.

The portal information storing unit 3301 may store the latitude and longitude of the target place determined from the latitude and longitude of the client terminal 100, and a unique index value of the target place as portal information for the corresponding user.

The portal information storing unit 3301 may provide a list of portals as the status of each user's owned portals when the client terminal 100 makes an information provision request.

The portal information sharing unit 3303 may provide other designated user with the portal information when the client terminal 100 makes a sharing request.

For example, the portal information sharing unit 3303 may cause a portal transmission symbol to be displayed on the other user's game screen.

Further, when the other user selects to add the corresponding portal, the portal information storing unit 3301 may store the portal information by adding the corresponding portal information to the other user's list of portal information.

When the user selects a specific portal for movement in the game space the movement unit 3305 may provide the client terminal 100 with the corresponding portal information, that is, a location value and a unique index of the target place.

In this case, according to the embodiment, when the user attempts to move to a target place in the game space via the portal, the movement unit 3305 may receive map data according to latitude and longitude of a preset wide region (also referred to as a “target region”) in which the target place is located, and provide the client terminal 100 with a map image of the target region.

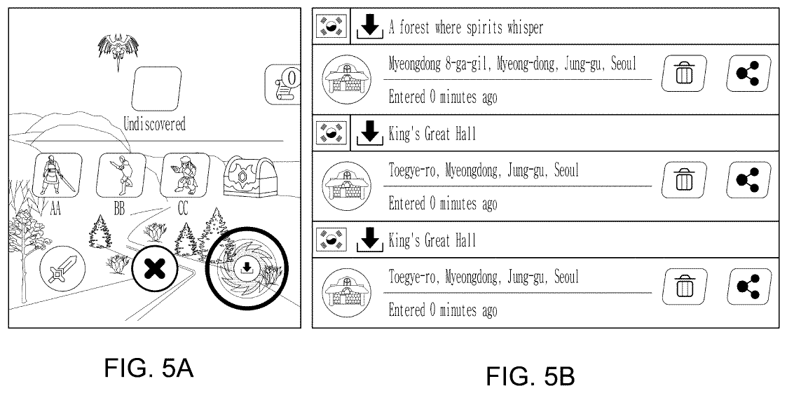

For example, as illustrated in (a) of FIG. 5, a player may enter and explore a specific place in the activity area of the game space, and when the player clicks the symbol in the bold circle at the bottom right end, the portal information storing unit 3301 may store information about the specific place as portal information.

Further, as illustrated in (b) of FIG. 5, the portal information storing unit 3301 may store a list of portal information for each user and provide the user with the list of portal information.

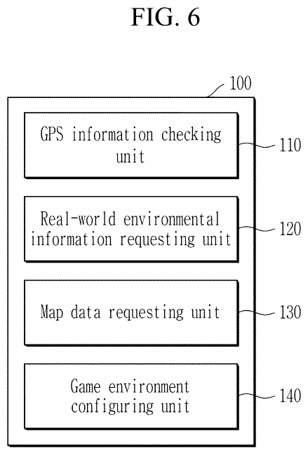

FIG. 6 is a detailed configuration diagram illustrating the client terminal 100 according to an aspect of the present disclosure.

As illustrated, the client terminal 100 may include a GPS information checking unit 110, a real-world environmental information requesting unit 120, a map data requesting unit 130, and a game environment configuring unit 140.

The GPS information checking unit 110 may check the current location information of the client terminal 100 via the satellite 400.

The real-world environmental information requesting unit 120 may receive real-world environmental information from the API server 500 based on the GPS values to be utilized in configuring the game environment.

For example, the real-world environmental information requesting unit 120 may receive various real-world environmental information, such as weather, temperature, wind speed, precipitation, fine dust, stock price, or traffic, at the corresponding location from the API server 500.

The map data requesting unit 130 may request map data from the map server 600 based on the player's GPS location, and for example, may receive map data in a tiled format representing geographic features of the area.

The game environment configuring unit 140 may configure a game environment for the player that is linked to the real-world environmental information via an interaction available game environment configuration matching table pre-downloaded from the game server 300.

In addition, the game environment configuring unit 140 may display a map of the target region using the stored portal information and provide a game environment configuration that matches the real-world environmental information of the target region when a player in the game space attempts to move to the target place via the portal.

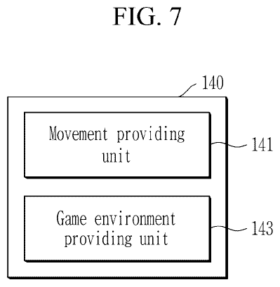

More specifically, as illustrated in FIG. 7, the game environment configuring unit 140 may include a movement providing unit 141 and a game environment providing unit 143.

The movement providing unit 141 may request a map image of the target region from the map server 600 using latitude and longitude values as stored portal information and display the map image when the player intends to move to the target place via the portal, and may provide a scene in which the player enters the corresponding movement target region.

In this case, the movement providing unit 141 may provide a map image of the preset accumulation for the target region, and in some embodiments, may also provide a map image of the movement section from the current region to the movement target region.

Alternatively, in some embodiments, the movement providing unit 141 may display a longer movement scene time proportional to the length of the movement distance based on the GPS value between the current location and the location of the movement target region.

After the player enters the target region, the game environment providing unit 143 may provide a game environment configuration that matches the real-world environmental information of the target region.

Based on the game environment configuration matching table described above, the game environment providing unit 143 may provide a game environment configuration that is linked to the real-world environmental information of the target region.

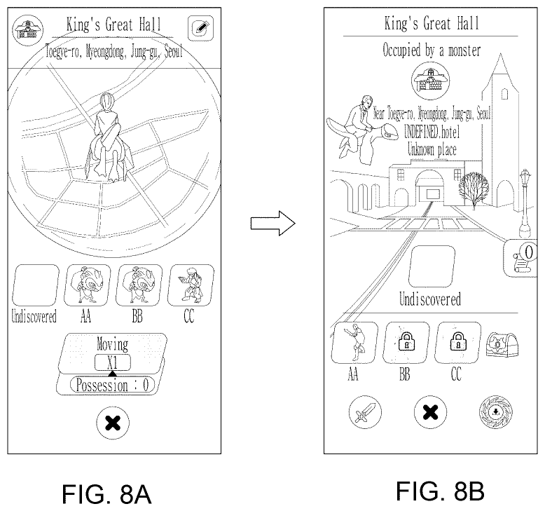

FIG. 8 is an example screen for a case where a player enters a target place through a portal.

First, as illustrated in FIG. 8(a), when a player intends to move to a target place (the King's Great Hall) on the Toegye-ro in South Korea via the portal, the movement providing unit 141 may display a map image of a preset accumulation for the target region, Toegye-ro, Myeongdong, Jung-gu, Seoul, South Korea.

The movement providing unit 141 may provide a scene in which the player enters the target place on the map image as illustrated.

The game environment providing unit 143 may request real-world environmental information of the target region from the API server 500, and may provide a game environment configuration that is linked to the real-world environmental information of the target region after the player enters, for example, the game environment providing unit 143 may provide the King's Great Hall as a game environment configuration that matches a hotel in the real-world environment as illustrated in FIG. 8(b).

And the game environment providing unit 143 may provide monsters, items, and the like as the game environment configuration that matches according to information on weather, temperature, time, and the like of the target region.

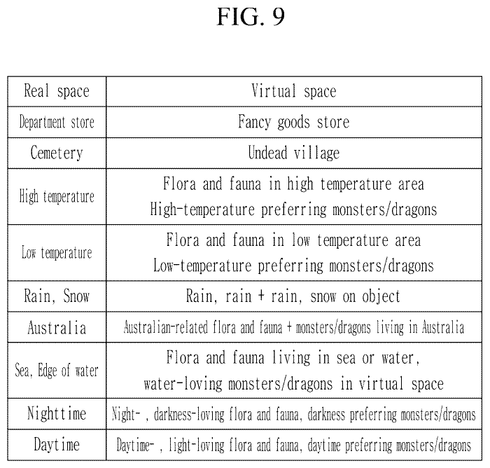

FIG. 9 is an example of a table defining interaction available game environment configurations matching according to real-world environmental information.

That is, as illustrated, for example, when the geographic information provided by map data of the area in which the player is currently located includes a department store, an apartment complex, or a cemetery, the game place may be formed of a fancy goods store, an orc village, or an undead village, respectively.

Also, when the temperature of the current location is high, the game environment may be configured with real-world flora and fauna that live in warmer climates, or monsters or dragons that are set to prefer higher temperatures in the game in the game place. Also, when the temperature of the current location is low, the game environment may be configured with real-world flora and fauna that live in colder climates, or monsters or dragons that are set to prefer lower temperatures in the game in the game place.

Similarly, if it is raining or snowing in the real world, the rain or snow may be represented in the corresponding game place, and each object in the game may be represented as pooling rain or accumulating snow.

Further, for example, when the player's actual location is Australia, Australian-related flora and fauna and monsters or dragons that are set to live in Australia may appear in the game place.

Also, when the player's current location is sea or at the edge of the water, the virtual game place may include flora and fauna that live in the sea or water in the real world, and monsters or dragons that are set to be water-loving in the game.

Further, when the player's real-world environment is night or day, the matching game environment may be composed of night-loving and dark-loving flora and fauna, and monsters or dragons set to prefer darkness, or light-loving flora and fauna, and monsters or dragons set to prefer day.

Thus, according to the present disclosure, when a user wishes to move from a current place to a target place in a game space via a portal, it is possible to provide the effect similar to the movement of the player in the real-world through the map data of the target region or movement section.

In addition, the game environment configuration may be provided that is linked to the real-world environmental information in the real world of the target region after the player's movement, so that the player may enjoy game developments progressing differently while being matching the respective environmental information in various places.

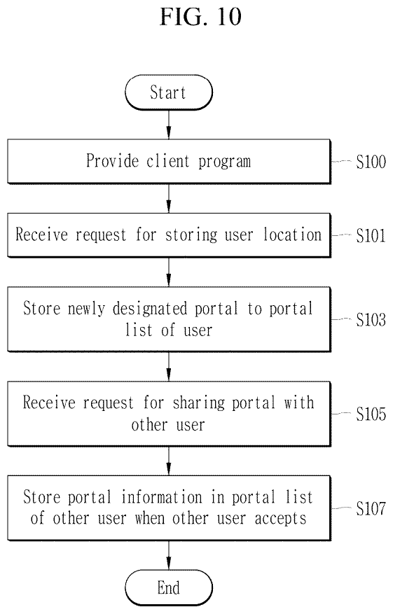

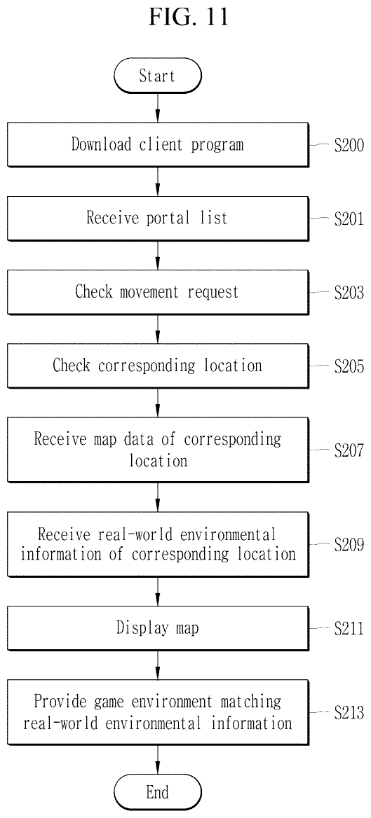

Hereinafter, there will be described the overall flow of providing, by the game server and the client terminal, a game environment configuration for storing information about a specific place in a game space, moving the game space by utilizing the stored information of the specific place, and matching the real-world environmental information of the target place after movement according to an aspect of the present disclosure with reference to FIGS. 10 and 11.

First, as illustrated in FIG. 10, the game server 300 may provide the client terminal 100 accessed for game play with a client program, such that a matching table between current real-world environmental information and an interaction available game environment is set, and the client terminal 100 communicates with the external servers 300, 500, and 600 to execute game play (S100).

In this case, the game server 300 may receive a portal designation request for the target place from the client terminal 100 during game execution (S101).

The game server 300 may store portal information for the target place, for example, location values, such as latitude and longitude of the target place, and unique index information of the target place.

The game server 300 may manage a list of portals designated by a user, that is, a list of portals per user, and may add a newly designated portal to the portal list of the corresponding user (S103).

The game server 300 may then receive a request from the client terminal 100 to share certain portal information with another user. The game server 300 may indicate that a portal sharing event has occurred on the client terminal 100 of another user, and when another user accepts the sharing request, the game server 300 may add the corresponding portal information to the other user's portal list and store the portal information (S107).

FIG. 11 illustrates an overall flow in which a player moves to a target place via a portal in the client terminal 100 and a game environment configuration that matches real-world environmental information is provided at the target place.

The client terminal 100 may download a client program required for accessing the game from the game server 300, which may be provided with a matching table between the real-world environmental information and the interaction available game environment (S200).

The client terminal 100 may receive a list of portals stored by the user from the game server 300 (S201).

When the user selects a specific portal to move to a target place, the client terminal 100 may check the corresponding portal information to check the location of the target place and request a map image of the target region from the map server 600 (S203, S205, and S207).

The client terminal 100 may also receive real-world environmental information of the target region via the API server 500 (S209).

The client terminal 100 may provide the user with a map image of the target region and provide a scene in which the player enters the map toward the target place (S211).

In this case, it has been described that in some embodiments, the client terminal 100 may provide the map image throughout the movement section from the current region to the movement target region.

The client terminal 100 may configure a game environment that matches the received real-world environmental information of the target region, and provide the configured game environment after the player enters the target place using the portal (S213).

In other words, depending on the received real-world environmental information, the type of target region, the type of monsters or dragons that appear, and the like may be provided differently.

In the foregoing, it has been described that the client terminal 100 communicates with the map server 600 and the API server 500 to receive location-specific map data and real-world environmental information and provide map images related to place movement by using the player's portal and provide the game environment configuration at the moved place, but, it is a matter of course that in some embodiments, the game server 300 may be configured to communicate with the map server 600 and the API server 500 to receive and deliver map data and real-world environmental information, or to provide a game environment configuration in the moved place.

The exemplary embodiments of the present disclosure described above are not only implemented through the apparatus and method, but may also be implemented through programs that realize functions corresponding to the configurations of the exemplary embodiment of the present disclosure, or through recording media on which the programs are recorded.

Although an exemplary embodiment of the present disclosure has been described in detail, the scope of the present disclosure is not limited by the exemplary embodiment. Various changes and modifications using the basic concept of the present disclosure defined in the accompanying claims by those skilled in the art shall be construed to belong to the scope of the present disclosure.

<Description of symbols>

| | |
|---|---|
| 100: Client terminal | 110: GPS information |
| | checking unit |
| 120: Real-world environmental information | |
| requesting unit | |
| 130: Map data requesting unit | |
| 140: Game environment configuring unit | |
| 141: Movement providing unit | |
| 143: Game environment providing unit | |
| 200: Service server | |
| 210: User access unit | |
| 220: Membership information registering | |
| unit | |
| 230: Membership managing unit | 300: Game server |
| 310: Client program providing unit | 320: Game providing unit |
| 330: Portal processing unit | 400: Satellite |
| 500: API server | 600: Map server |
| 3301: Portal information storing unit | |
| 3303: Portal information sharing unit | |
| 3305: Movement unit | |

What is claimed is:

1. A system for space movement in a game, the system comprising:
a service server for receiving membership information of game service users from client terminals and registering the received membership information, and executing membership management; and
a game server for providing a client program for executing a game to the client terminal,
wherein when the game server receives a portal designation request for a target place in an activity area of a game space during game execution from the client terminal, the game server stores information including a location value for the target place determined from a GPS value of the client terminal as portal information, and
when a user selects a specific portal for movement during game execution, the game server causes a game space to be moved to a target place by using the portal information and provides a game environment configuration linked to real-world environmental information of the real world corresponding to the location value of the target place.

2. The system of claim 1, wherein:
the portal information further includes a unique index value for the target place.

3. The system of claim 2, wherein:
the game server includes:
a client program providing unit for providing the client terminal with the client program for executing the game;
a game providing unit for providing player information; and
a portal processing unit for receiving the portal designation request and storing the portal information for the target place and providing the portal information when the client terminal makes a request for the portal information, causing the client terminal to display a map image based on the location value of the target place by using the portal information when the user selects a specific portal during game execution, and providing a game environment configuration matching real-world environmental information of the real world corresponding to the location value of the target place when a player enters the map image such that game space of the player is moved.

4. The system of claim 3, wherein:
the portal processing unit includes:
a portal information storing unit for receiving the portal designation request and storing the portal information for the target place;
a portal information sharing unit for providing information about a specific portal to a designated other user upon receiving a sharing request for the specific portal from the client terminal; and
a movement unit for providing the client terminal with the information of the specific portal when the user selects the specific portal for movement during game execution, and causing the client terminal to display a map image of the target place and provide a game environment configuration matching real-world environmental information.

5. The system of claim 4, wherein:
the portal information sharing unit causes a portal transmission symbol to be displayed on the game screen of designated other user when receiving a portal sharing request, and
when the other user approves addition of a corresponding portal, the portal information storing unit stores information about the corresponding portal as portal information of the other user.

6. The system of claim 3, wherein:
the client program providing unit also provides a matching table defining a game environment configuration linked based on real-world environmental information through the client program to cause the client terminal to provide a game environment configuration matching real-world environmental information of the real world corresponding to a location value of a target place based on the matching table by using the portal information when the user selects a specific portal during game execution.

7. The system of claim 3, wherein:
the real-world environmental information includes one or more of temperature, country, weather, altitude, time, wind, fog, UV light, precipitation, fine dust, stock price information, and traffic information.

8. A method of space movement in a game by a system, the method comprising:
a) providing an accessed client terminal with a client program for executing a game; and
b) when receiving a portal designation request for a target place in an activity area of a game space during game execution from the client terminal, storing information including a location value for the target place determined from a GPS value of the client terminal as portal information, and when a user selects a specific portal for movement during game execution, causing a game space to be moved to a target place by using the portal information and providing a game environment configuration linked to real-world environmental information of the real world corresponding to the location value of the target place.

9. The method of claim 8, wherein:
the portal information further includes a unique index value for the target place.

10. The method of claim 9, wherein:
the operation b) includes
receiving the portal designation request and storing the portal information for the target place, and providing the client terminal with the portal information when the client terminal makes a request for the portal information to cause the client terminal to display a map image based on the location value of the target place by using the portal information when the user selects a specific portal during game execution, and provide a game environment configuration matching real-world environmental information of the real world corresponding to the location value of the target place when a player enters the map image such that game space of the player is moved.

11. The method of claim 10, further comprising:
providing information about a specific portal to a designated other user upon receiving a sharing request for the specific portal from the client terminal.

12. The method of claim 11, further comprising:
when receiving approval to add a corresponding portal from other user, storing information about the corresponding portal as portal information of the other user.

13. The method of claim 10, wherein:
the operation a) includes
providing a matching table defining a game environment configuration linked based on real-world environmental information in which a user is located through the client program, and
the operation b) includes
causing the client terminal to provide a game environment configuration based on the matching table by using the portal information when the user selects a specific portal during game execution.

14. The method of claim 10, wherein:
the real-world environmental information includes one or more of temperature, country, weather, altitude, time, wind, fog, UV light, precipitation, fine dust, stock price information, and traffic information.

15. A recording medium for storing a program executing a method of performing space movement in a game,
wherein the method comprises:
storing, by a device, a matching table including a game environment configuration matching each of real-world environmental information;
providing, by the device, as portal information, information including a location value for a target place determined from a GPS value of the device in an activity area of a game space during game execution;
receiving, by the device, a list of stored portals and, when a specific portal is selected for movement through the game space, receiving, based on information about the portal, a map image of the target place and real-world environmental information of the real world corresponding to the location value of the target place;
displaying, by the device, a map image of the target place; and
when the player enters the map image, providing, by the device, based on the matching table, a game environment configuration matching real-world real environmental information of the target place.

16. The recording medium of claim 15, wherein:
the portal information further includes a unique index value for the target place.

17. The recording medium of claim 16, wherein:
the real-world environmental information includes one or more of temperature, country, weather, altitude, time, wind, fog, UV light, precipitation, fine dust, stock price information, and traffic information.
